(19) United States
(12) Patent Application Publication
(10) Pub. No.: US 2013/0006748 A1
(43) Pub. Date: Jan. 3, 2013

(54) DATA SAMPLING AND USAGE POLICIES FOR LEARNING AND PERSONALIZATION WITH PRIVACY

(75) Inventors: Eric Horvitz, Kirkland, WA (US); Lili Cheng, Bellevue, WA (US)

(73) Assignee: MICROSOFT CORPORATION, Redmond, WA (US)

(21) Appl. No.: 13/171,951

(22) Filed: Jun. 29, 2011

(51) Int. Cl. G06Q 30/00; G06F 21/00

(52) U.S. Cl. 705/14.39; 726/26

(57) ABSTRACT

Various embodiments are described for systems and methods for facilitating data sharing between a user of a client device and an online service. The system may include a module configured to display a graphical display of data sharing specifications on the client device. The graphical display may include one or more user-adjustable privacy setting selectors configured to receive input of user-selected privacy level selections. Each of the privacy level selections may be associated with a report of the probability that data attributes will be captured and used and/or with other measures such as the size of the set of people that are identifiable from the revelation. Data attributes may include a data type, a data use purpose, a data use timeframe, and a data storage timeframe. The graphical display may further include a consent selector configured to receive consent from the user.

### BACKGROUND

Online service providers that provide services such as web search engines, news portals and e-commerce platforms endeavor to provide high-quality services to large, heterogeneous user populations. Service to individual users may be personalized by using knowledge about the user, such as aspects of a user's demographics, location and past online activity. Such personalization may provide benefits to the user in the form of delivery of content that is more appropriately tailored to the user's personal interests.

However, the benefits of personalization should be delivered in a manner that protects the privacy expectations of users, follows applicable privacy laws, and adheres to the privacy policies of the service provider itself. As increasing amounts of personal information are acquired by a service provider about a user, the user becomes a member of an increasingly smaller group of people associated with the same attributes. In this manner, the user also becomes increasingly identifiable. However, the user may not wish to be too particularly identifiable to many of the service providers with which the user has relationships. Further, in many cases the user has no way of ascertaining how identifiable the user has become to a service provider, adding to a general feeling of uneasiness regarding the user's online privacy. Additionally, users may have limited awareness of the benefits of personalized service that are enabled by providing more personal data to a service provider. Under these conditions, service providers face challenges in meeting users' privacy expectations while at the same time in delivering highly personalized experiences for users.

### SUMMARY

To address the above issues, systems and methods for facilitating control of data sharing between a user of a client device and an online service are provided. The system may include a module that is configured to provide data sharing controls and visualizations via a graphical user interface on a display of the client device. The graphical user interface may include one or more user-adjustable privacy setting selectors that are configured to receive input from the user of user-selected data-sharing or privacy level selections. Each of the selections corresponds to a measure of data sharing, such as a measure of probability associated with sharing a data attribute. The privacy data attribute is selected from a group consisting of a data type, a data use purpose, a data use timeframe, and a data storage timeframe. The graphical user interface may also include a consent selector configured to receive a consent from the user.

According to another aspect of the present invention, systems and methods for facilitating privacy data trading between a user of a client device and an online service are provided. The system may facilitate the sharing by an individual of personal data, such as aspects of logs of online activities and locations, as sensed or collected by applications running on one or more client devices. The system may include a privacy trading module that is configured to display a privacy trading graphical user interface on a display of the client device. The privacy trading graphical user interface may include a plurality of user-adjustable privacy setting selectors that are configured to receive input from the user of user-selected privacy level selections. Each of the privacy level selections corresponds to a measure of identifiability for an associated privacy data attribute. The privacy data attribute is selected from a group consisting of a data type, a data use purpose, a data use timeframe, and a data storage timeframe. The privacy trading graphical user interface also includes an incentive display region that displays an incentive offered in exchange for the user-selected privacy level selections.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a privacy data trading system including a client device and a privacy trading graphical user interface according to an embodiment of the present disclosure.

FIG. 2 is a schematic view of a first example screen of the privacy trading graphical user interface of FIG. 1.

FIG. 3 is a schematic view of a second example screen of the privacy trading graphical user interface of FIG. 1.

FIG. 4 is a schematic view of a third example screen of the privacy trading graphical user interface of FIG. 1.

FIG. 5 is a schematic view of a fourth example screen of the privacy trading graphical user interface of FIG. 1.

FIG. 6 is a schematic view of a flow chart for a method of facilitating privacy data trading between a user of a client device and an online service according to an embodiment of the present disclosure.

### DETAILED DESCRIPTION

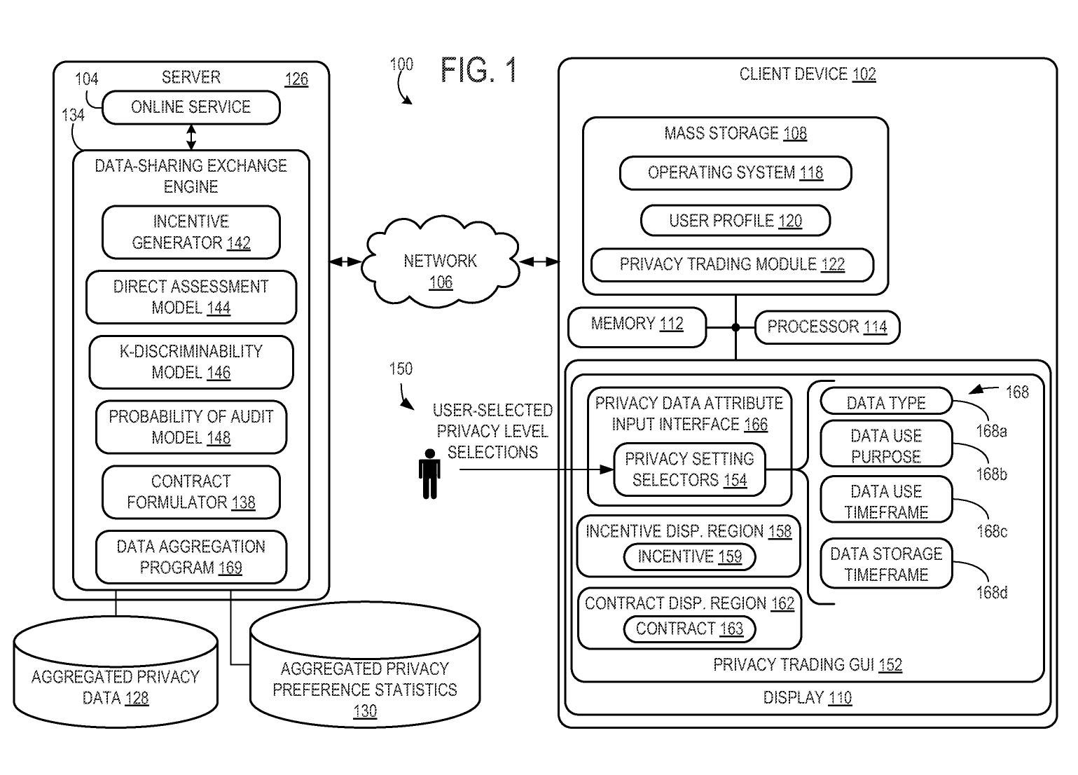

Aspects of this disclosure will now be described by example and with reference to the illustrated embodiments listed above. FIG. 1 is a schematic view of system 100 for facilitating privacy data trading between a user of a client device 102 and an online service 104. The client device 102 communicates with the online service 104 through a network 106.

In different embodiments, the client device 102 may take the form of a desktop computer, laptop computer, tablet computer, home entertainment computer, network computing device, mobile computing device, mobile communication device, gaming device, etc. Additionally, the network 106 may take the form of a local area network (LAN), wide area network (WAN), wired network, wireless network, personal area network, or a combination thereof, and may include the Internet.

The client device 102 includes mass storage 108, a display 110, memory 112 and a processor 114. Programs stored in mass storage 108 may be executed by the processor 114 using memory 112 to achieve various functions described herein. Mass storage 108 may include an operating system 118, one or more user profiles 120, and a privacy trading module 122. In other embodiments client device 102 may include other components not shown in FIG. 1, such as user input devices including keyboards, mice, game controllers, cameras, microphones, and/or touch screens, for example.

Online service 104 may be any network-based service that collects data from users, such as e-commerce portals, information portals, web-based applications (e.g., email, calendar, document, images, video, and music), advertising services, application stores, and online services that communicate with applications executed on mobile devices. Online service 104 is typically executed on a server 126, which is configured to communicate over a network with an aggregated privacy data database 128 and an aggregated privacy preference statistics database 130. Server 126 includes a data-sharing exchange engine 134 to communicate with the client device 102 and facilitate data sharing between the online service 104 and the client device. As explained in more detail below, the data-sharing exchange engine 134 can include one or more payment models including a direct assessment model 144, a k-discriminability model 146 and a probability of audit model 148. In one example a payment model may be selected by the online service 104 for a particular privacy data exchange with a user of client device 102 based on a specification of the online service 104, prior privacy data exchanges with the user, or other criteria.

The data-sharing exchange engine 134 includes an incentive generator 142 to determine an incentive to offer the user of the client device 102 in exchange for the privacy data and corresponding user-selected privacy level selections 150 offered by the user, and based on at least the selected payment model. The data-sharing exchange engine 134 also includes a contract formulator 138 to generate a privacy exchange contract that is presented to the user on the display 110 of the client device 102. The contract contains a textual description of the elements of the proposed privacy data exchange, including the privacy data attributes 168 and corresponding user-selected privacy level selections 150 offered by the user, and the incentive offered by the online service 104.

With continued reference to FIG. 1, the privacy trading module 122 of the client device 102 is configured to display a privacy trading graphical user interface (e.g., GUI) 152 on the display 110. The privacy trading GUI 152 includes a plurality of user-adjustable privacy setting selectors 154 that are configured to receive input, of user-selected privacy level selections 150 from a user of the client device 102. The user-adjustable privacy setting selectors 154 may take the form of individual check boxes, slider elements, drop-down menus, or other suitable input mechanisms. As explained in more detail below, each user-adjustable privacy setting selector 154 is associated with a privacy data attribute 168 related to the user of the client device 102. In the privacy trading GUI 152, each privacy data attribute 168 is displayed in a privacy data attribute input interface 166 proximate to a corresponding user-adjustable privacy setting selector 154.

it will be appreciated that the online service 104 may strive to improve and personalize its service to customers by using and storing data about its customers, such as in aggregated privacy data database 128. Depending upon the particular operations of the online service 104, customer data of various data types may have value for one or more data use purposes over a data use timeframe, and may have value being stored for a data storage timeframe, in the descriptions that follow, such customer data types and their use purposes and related use and storage timeframes are collectively referred to as privacy data attributes 168.

Privacy data attributes 168 may include, but are not limited to, a data type 168a, a data use purpose 168h, a data use timeframe 168c and a data storage timeframe 168d. A data type 168a may include, but is not limited to, a user's demographic information, behavior information, and/or geographic information. A user's demographic information may include, but is not limited to, characteristics such as a user's gender, age, income range, marital status, educational attainment, nationality, language(s), employment status, and home ownership status, for example. A user's behavior information may include, but is not limited to, search and browsing activity, browser type, calendar and contact information, and metadata associated with content on a user's computing device, such as calendar items indicating a user is participating in a type of event. A user's geographic information may include, but is not limited to, a user's past and present residences, the user's past and present location, and the location of a user's computing device. By providing a data structure for the privacy data attributes that includes data types such as those listed above, the user may be given greater ability to understand the types of data that are collected and authorize the communication of certain of these data types to the online service 104.

A data use purpose 168b may include, but is not limited to, how the online service 104 may use and/or share user information related to data type 168a. For example, a data use purpose 168b may include serving personalized advertisements to the user. A data use timeframe 168c may include, but is not limited to, how long the online service 104 may use information related to data type 168a for the data use purpose(s) 168b. For example, a data use timeframe 168c may be the past two days, two months, or two years, or other duration, or may be a range such as data that is more than 1 year old. A data storage timeframe 168d may include, but is not limited to, how long the online service 104 may store before deleting information related to data type 168a. For example, a data storage timeframe 168d may be three months, three years, or other suitable timeframe.

With continued reference to FIG. 1, each of the user-adjustable privacy setting selectors 154 enables the user to make a user-selected privacy level selection that corresponds to a measure of identifiability for the associated privacy data attribute 168. The measure of identifiability may indicate membership in a particular group, such as gender, and/or may quantify the size or data range of a group associated with a privacy data attribute. For example, where the privacy data attribute is the current location of the user, the corresponding user-adjustable privacy setting selector 154 may allow the user to select the granularity of location information to share (e.g., country, state, county, city, block, zip code, address, surrounding one-mile radius, etc.). In another example, where the privacy data attribute is the age of the user, the corresponding user-adjustable privacy setting selector 154 may allow the user to select the age group that contains the age of the user. In another example, the user-adjustable privacy setting selector 154 may allow the user to select the size of the user's age group that the user desires to disclose to the online service 104. The age group ranges offered to the user may include ten-year ranges (18-27, 28-37, 38-47, etc), seven-year ranges (18-24, 25-31, 32-38, etc.) four-year ranges (18-21, 22-25, 93-26, etc.), one-year ranges (18, 19, 20, etc.), or other ranges as desired. In another example, the measure of identifiabililty may offer periods of time for the data use timeframe 168c and/or the data storage timeframe 168d.

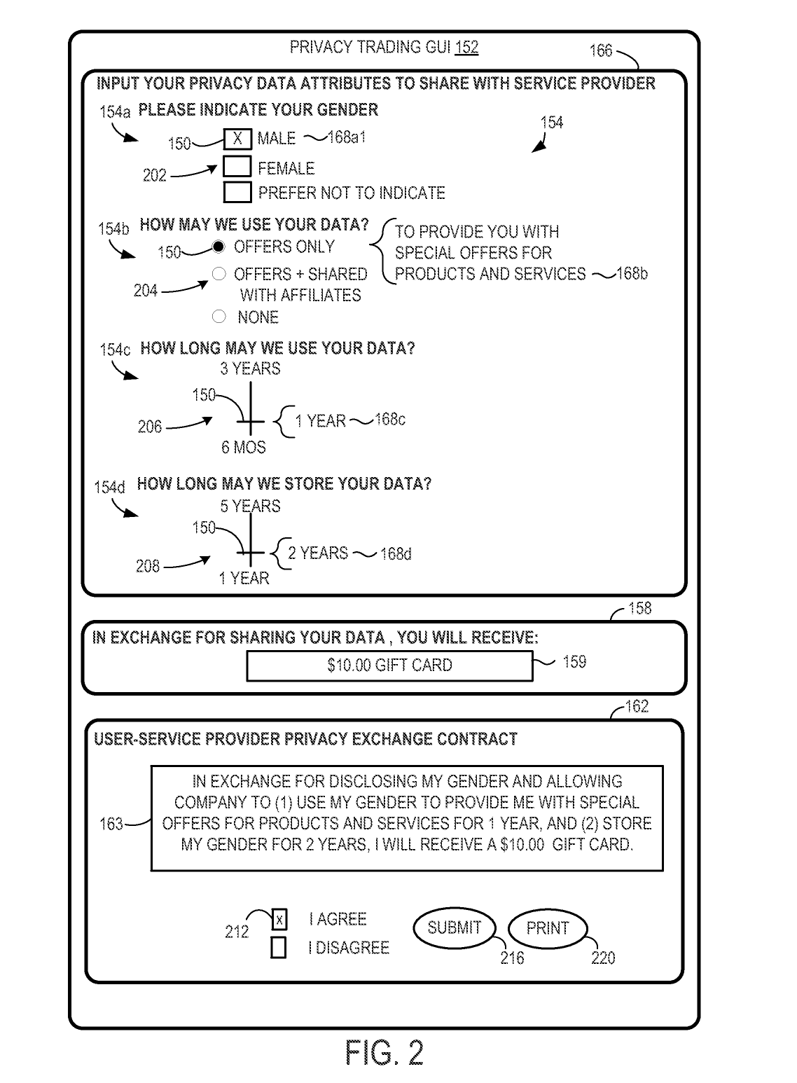

The privacy trading GUI 152 also includes an incentive display region 158 to display an incentive generated by the incentive generator 142 and offered in exchange for the privacy data and corresponding user-selected privacy level selections 150. The privacy trading GUI 152 further includes a contract display region 162 to display a privacy exchange contract generated by the contract formulator 138 that contains a full description of the elements of the proposed privacy data exchange. The privacy trading GUI 152 will be described in further detail below with reference to example screens shown in FIGS. 2-4.

As the descriptions that follow illustrate, the system 100 receives user input of the various privacy data attributes 168 via the privacy setting selectors 154 and processes the user input to generate an incentive 159 displayed in incentive display region 158 and a privacy contract 163 displayed in contract display region 162.

With reference now to FIGS. 1 and 2, an example of a privacy data exchange between a user of the client device 102 and the online service 104 will be discussed. FIG. 2 is a schematic view of an example screen of the privacy trading GUI 152 of FIG. 1. In FIG. 2 the online service 104 has selected a direct assessment model 144 for the payment model. In this example, the online service is requesting privacy data attributes 168 desired by the online service and related to the direct assessment model. A plurality of privacy setting selectors 154 are provided in privacy data attribute input interface 166, including a gender selector 154a, a usage type selector 154b, a length of usage selector 154c, and a length of storage selector 154d. While checkboxes, radio buttons, and sliders are illustrated herein for these privacy setting selectors 154, it will be appreciated that a variety of other input mechanisms may be utilized.

Gender selector 154a is configured to receive a privacy level selection 150 via checkboxes 202, indicating that the gender of the user is male, female, or undisclosed. In the illustrated example, the user has selected “male”. Accordingly, the data type 168a1 for “gender” is set to “male”.

Usage type selector 154b is configured to receive input from the user indicating how the online service 104 may use the user's data. In this example, the usage type selector 154b is illustrated as radio buttons 204, among which the user has selected the “offers only” button, causing the corresponding description “To provide you with special offers for products and services” to appear. According to the user input, the data use purpose 168b is set to “offers only.” Another option, not selected in FIG. 2, would also allow the online service 104 to share the user's data with its affiliates. It will be appreciated that many other examples of data use options may be presented to the user via usage type selector 154b.

Length of usage selector 154c is configured to receive a privacy level selection 150 via slider 206 indicating the data use time frame 168c during which the online service 104 may use the user's data. As the user adjusts the slider element between the shortest time frame offered, in this example 6 months, and the longest time frame offered, in this example 3 years, the data use time frame 168c corresponding to a current position of the slider element 206 is displayed (1 year in the configuration of FIG. 2). It will be appreciated that while in this example embodiment the length of usage selector 154c is illustrated as a slider element 206, various other input mechanisms alternatively may be utilized to enable the user to adjust and select the desired data usage time frame 168c.

Length of storage selector 154d is configured to receive a privacy level selection 150 via slider element 208 indicating a data storage time frame 168d during which the online service 104 may store the user's data. While the length of storage selector 154d is illustrated as a slider element 208, it will be appreciated that a variety of other controls may be utilized to enable the user to adjust and select the desired data storage time frame 168d.

Referring to FIG. 1., as the user inputs privacy level selections through the plurality of privacy setting selectors 154, these privacy level selections are sent to the data-sharing exchange engine 134 associated with the online service 104 and executed on server 126, typically via privacy trading module 122 at the client device and the network 106. The incentive generator 142 of the data-sharing exchange engine 134 analyzes the user-selected privacy level selections 150 to generate an incentive 159 to offer the user in exchange for the user-selected privacy level selections 150. In one example, the incentive 159 corresponds to an estimated value to the user of the user-selected privacy level selections 150. It will be appreciated that the incentive generator 142 may also utilize other criteria in determining the incentive, such as the estimated value to the online service 104 of the user-selected privacy level selections, a user's previous interactions with the online service, etc. The data-sharing exchange engine 134 sends the incentive 159 generated by the incentive generator 142 via the network 106 to the client device 102, where it is received by the privacy trading module 122 and displayed in the incentive display region 158 of the privacy trading GUI 152, as shown in FIG. 2.

As described above, the data-sharing exchange engine 134 also includes a contract formulator 138 that generates a contract 163 containing a textual description of the elements of the proposed privacy data exchange, including the privacy data attributes and corresponding user-selected privacy level selections 150 offered by the user, and the incentive offered by the online service 104. With reference to FIG. 2, a textual description of the user-selected privacy level selections 150 and the incentive offered in exchange for the user's data are presented in a contract 163 displayed in contract display region 162. In other examples the contract display region 162 may also display visual indicators that convey the user-selected privacy level selections 150, such as graphs, charts, icons, etc. When the user is satisfied with the proposed privacy data exchange and corresponding contract, the user may select a selector such as checkbox 212 indicating “I Agree” and then may select the “Submit” button 216. The user may also print the description of the privacy data exchange in the contract display region 162 by selecting the “Print” button 220. The contract 163 provides not only further explanation and clarity to the user about the nature of the data exchange, but also confirms the user's consent to the exchange, and provides both the user and the service provider a legal framework to govern the exchange.

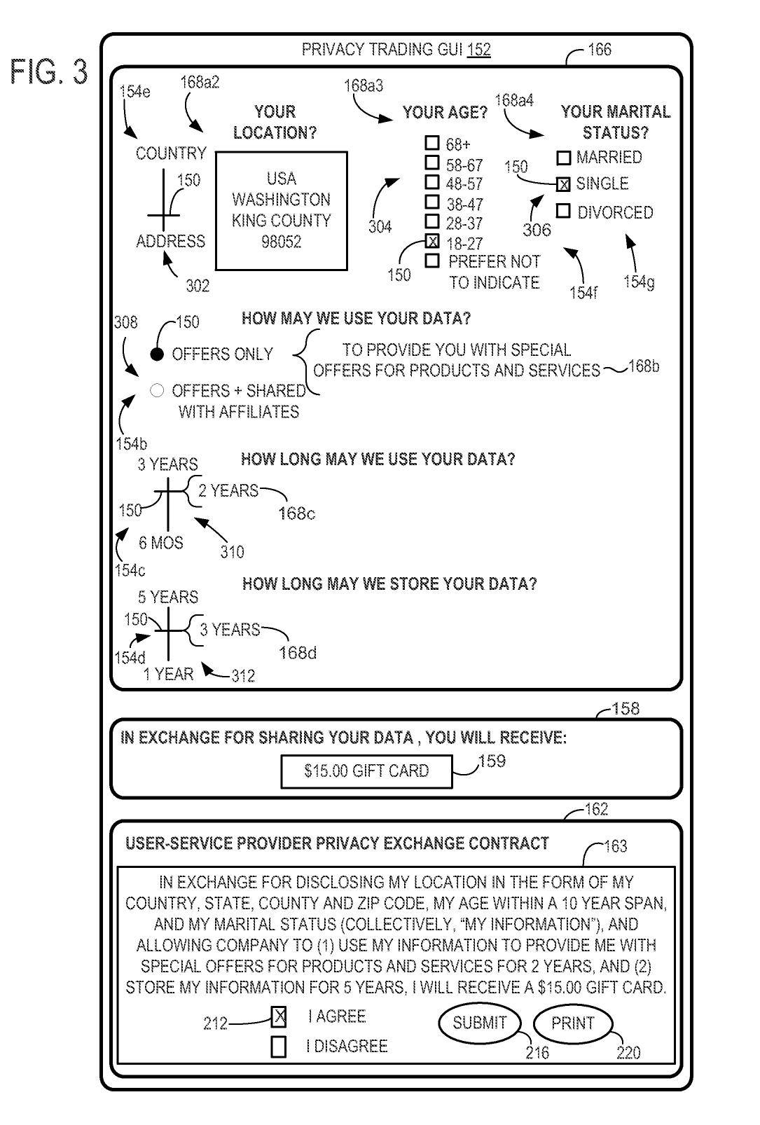

With reference now to FIG. 3, another example of a privacy data exchange between a user of the client device 102 and the online service 104 is illustrated. FIG. 3 is a schematic view of another example screen of the privacy trading GUI 152 of FIG. 1. In FIG. 3 the online service 104 has selected a k-discriminability model 146 for the payment model. In this example, the online service is requesting privacy data attributes 168 desired by the online service and related to the k-discriminabililty model. As with the example screen discussed above for FIG. 2, a plurality of privacy setting selectors 154 are provided in privacy data attribute input interface 166, including a location selector 154e, an age selector 154f, and a marital status selector 154g.

Location selector 154e is configured to receive a privacy level selection 150 via slider 302 indicating the level of detail of location information 168a2 that will be shared with the online service. As the user adjusts the slider element 302 between the most general location information to be shared, in this example the user's country, and the most specific location information to be shared, in this example the user's address, the level of detail of location information corresponding to a current position of the slider element 302 is displayed. In the illustrated example, the user has selected to disclose the user's country, state, county and zip code. Accordingly, the data type 168a2 for “location information” is set to USA, Washington, King County, and 98052. It will be appreciated that while in this example embodiment the location selector 154e is illustrated as a slider element 302, various other input mechanisms alternatively may be utilized to enable the user to adjust and select the desired level of detail of location information 168a1.

Age selector 154f is configured to receive a privacy level selection 150 via checkboxes 304 indicating an age range of the user. In the illustrated example, the user has selected the “18-27” age range, Accordingly, the data type 168a3 for “age” is set to “18-27”.

Marital status selector 154g is configured to receive a marital status selection 150 via checkboxes 306 indicating a marital status of the user in the illustrated example, the user has selected “single,” Accordingly, the data type 168a4 for “marital status” is set to “single”.

Usage type selector 154b is configured to receive input from the user indicating how the online service 104 may use the user's data, in this example, the usage type selector 154h is illustrated as radio buttons 308, among which the user has selected the “offers only” button, causing the corresponding description “To provide you with special offers for products and services” to appear. According to the user input, the data use purpose 168b is set to “offers only,” Another option, not selected in FIG. 2 would also allow the online service 104 to share the user's data with its affiliates. It will be appreciated that many other examples of data use options may be presented to the user via usage type selector 154b.

Length of usage selector 154c is configured to receive a privacy level selection 150 via slider 310 indicating the data use time frame 168c during which the online service 104 may use the user's data. As the user adjusts the slider element between the shortest time frame offered, in this example 6 months, and the longest time frame offered, in this example 3 years, the data use time frame 168c corresponding to a current position of the slider element 206 is displayed (2 years in the configuration of FIG. 3). It will be appreciated that while in this example embodiment the length of usage selector 154c is illustrated as a slider element 310, various other input mechanisms alternatively may be utilized to enable the user to adjust and select the desired data usage time frame 168c.

Length of storage selector 154d is configured to receive a privacy level selection 150 via slider element 312 indicating a data storage time frame 168d during which the online service 104 may store the user's data. While the length of storage selector 154d is illustrated as a slider element 312, it will be appreciated that a variety of other controls may be utilized to enable the user to adjust and select the desired data storage time frame 168d.

As described above with reference to FIGS. 1 and 2, the incentive generator 142 of the data-sharing exchange engine 134 analyzes the user-selected privacy level selections 150 to generate an incentive 159 to offer the user in exchange for the user-selected privacy level selections 150. The data-sharing exchange engine 134 sends the incentive 159 generated by the incentive generator 142 via the network 106 to the client device 102, where it is received by the privacy trading module 122 and displayed in the incentive display region 158 of the privacy trading GUI 152, as shown in FIG. 3.

Also as described above, the contract formulator 138 of the data-sharing exchange engine 134 generates a contract 163 containing a textual description of the elements of the proposed privacy data exchange, including the privacy data attributes and corresponding user-selected privacy level selections 150 offered by the user, and the incentive offered by the online service 104. With reference to FIG. 3, a textual description of the user-selected privacy level selections 150 and the incentive offered in exchange for the user's data are presented in a contract 163 displayed in contract display region 162. When the user is satisfied with the proposed privacy data exchange and corresponding contract, the user may select a selector such as checkbox 212 indicating “I Agree” and then may select the “Submit” button 216. The user may also print the description of the privacy data exchange in the contract display region 162 by selecting the “Print” button 220.

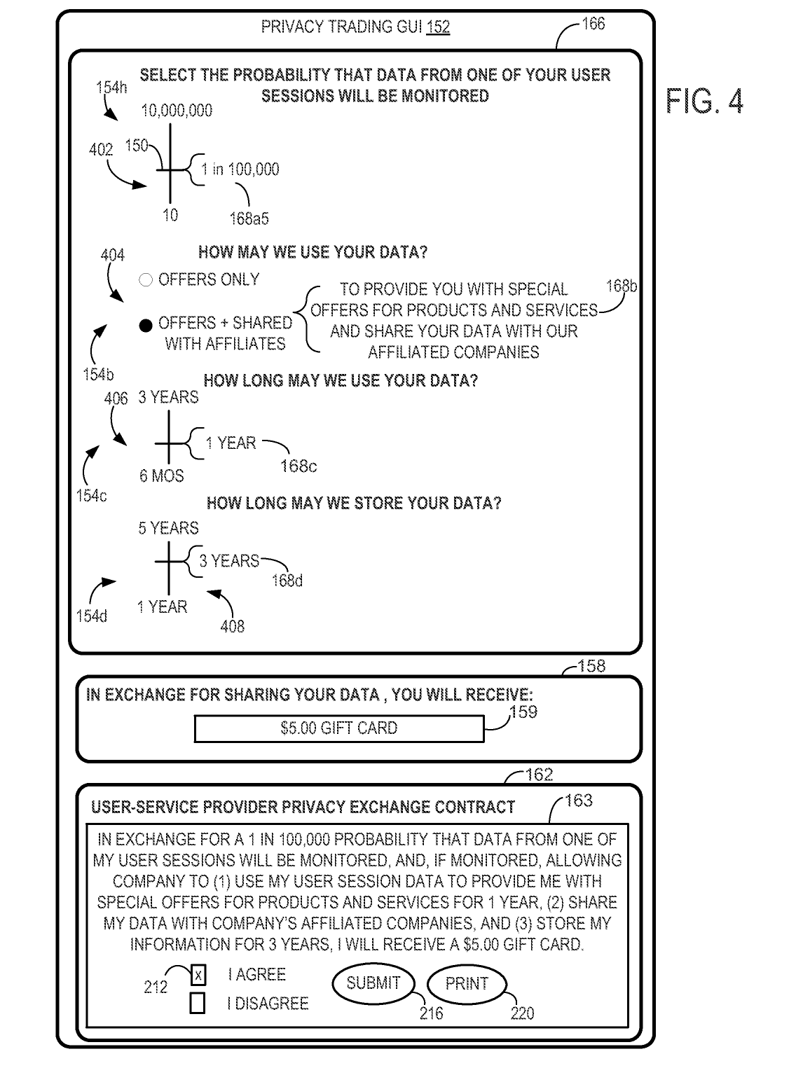

With reference nova to FIG. 4, another example of a privacy data exchange between a user of the client device 102 and the online service 104 is illustrated. FIG. 4 is a schematic view of another example screen of the privacy trading GUI 152 of FIG. 1. In FIG. 4 the online service 104 has selected a probability of audit model 148 for the payment model. In this example, the online service is requesting privacy data attributes 168 desired by the online service and related to the probability of audit model. As with the example screens discussed above for FIGS. 2 and 3, a plurality of privacy setting selectors 154 are provided in privacy data attribute input interface 166, including a probability of audit selector 154h.

Probability of audit selector 154h is configured to receive a privacy level selection 150 via slider 402 indicating the probability that data from one of the user's sessions will be monitored by the online service 104. As the user adjusts the slider element 302 between the most likely probability, in this example 1 in 10, and the most unlikely probability, in this example 1 in 10,000,000, the probability corresponding to a current position of the slider element 402 is displayed. In the illustrated example, the user has selected a probability of 1 in 100,000. Accordingly, the data type 168a5 for “probability of audit” is set to “1 in 100,000”, it will be appreciated that probabilities higher than 1 in 10, such as 1 in 8, 1 in 5, etc., may also be offered. Similarly, probabilities lower than 1 in 10,000,000, such as 1 in 15,000,000, 1 in 50,000,000, etc., may also be offered. It will also be appreciated that while in this example embodiment the location selector 154e is illustrated as a slider element 402, various other input mechanisms alternatively may be utilized to enable the user to adjust and select the desired probability of audit 168a5.

Usage type selector 154b is configured to receive input from the user indicating how the online service 104 may use the user's data. In this example, the usage type selector 154b is illustrated as radio buttons 404, among which the user has selected the “offers+shared with affiliates” button, causing the corresponding description “To provide you with special offers for products and services, and share your data with our affiliated companies” to appear. According to the user input, the data use purpose 168b is set to “offers+shared with affiliates,”

Length of usage selector 154c is configured to receive a privacy level selection 150 via slider 406 indicating the data use time frame 168c during which the online service 104 may use the user's data. As the user adjusts the slider element between the shortest time frame offered, in this example 6 months, and the longest time frame offered, in this example 3 years, the data use time frame 168c corresponding to a current position of the slider element 406 is displayed (1 year in the configuration of FIG. 4). Similarly, and as discussed above with reference to FIGS. 2 and 3, length of storage selector 154d is configured to receive a privacy level selection 150 via slider element 408 indicating a data storage time frame 1684 during which the online service 104 may store the user's data.

As described above with reference to FIGS. 1 and 2, the incentive generator 142 of the data-sharing exchange engine 134 analyzes the user-selected privacy level selections 150 to generate an incentive 159 to offer the user in exchange for the user-selected privacy level selections 150. The data-sharing exchange engine 134 sends the incentive 159 generated by the incentive generator 142 via the network 106 to the client device 102, where it is received by the privacy trading module 122 and displayed in the incentive display region 158 of the privacy trading GUI 152, as shown in FIG. 4.

Also as described above, the contract formulator 138 of the data-sharing exchange engine 134 generates a contract 163 containing a textual description of the elements of the proposed privacy data exchange, including the privacy data attributes and corresponding user-selected privacy level selections 150 offered by the user, and the incentive offered by the online service 104. With reference to FIG. 4, a textual description of the user-selected privacy level selections 150 and the incentive offered in exchange for the user's data are presented in a contract 163 displayed in contract display region 162. When the user is satisfied with the proposed privacy data exchange and corresponding contract, the user may select a selector such as checkbox 212 indicating “I Agree” and then may select the “Submit” button 216. The user may also print the description of the privacy data exchange in the contract display region 162 by selecting the “Print” button 220.

With reference now to FIG. 1, in another example the privacy trading GUI 152 may enable a user to select one or more user profiles 120 that are stored on the client device 102 in mass storage 108. A user profile 120 may include pre-defined user-selected privacy level selections 150 for one or more of the plurality of privacy data attributes 168, and may correspond to a context in which the user may use the client device 102.

Use Case Scenario

In one example use case scenario, a user may be planning a car trip and may desire to use a mapping service that provides directions via voice recognition technology through the user's client device 102, such as an in-car navigation system. The mapping service may require additional privacy data from the user, such as the user's specific location in this context, the user may be willing to trade disclosing his or her specific location in exchange for receiving the mapping service. Using the privacy trading GUI 152, the user may select a user profile 120 that discloses the user's specific location and includes other pre-selected privacy level selections 150 for other privacy data attributes 168 that correspond to utilizing the napping service in the user's in-car navigation system. It will be appreciated that other user profiles having various pre-defined user-selected privacy level selections 150 may be tailored to other use contexts.

According to another embodiment of the present invention, a system for facilitating control of data sharing between a user of a client device and an online service is provided. The system includes a module that is configured to display a graphical display on client device 102. In one example, the module may be privacy trading module 122 and the graphical display may be privacy trading GUI 152 as shown in FIG. 1.

The graphical display includes data sharing specifications that may include, for example, the one or more user-adjustable privacy setting selectors 154. As described above, the one or more user-adjustable privacy setting selectors 154 are configured to receive input of user-selected privacy level selections 150.

In one example, each of the privacy level selections 150 corresponds to a measure of probability associated with sharing an associated data attribute with the online service. The data attribute may include, for example, a data type 168a, a data use purpose 168b, a data use timeframe 168c, and a data storage timeframe 168d as described above. The measure of probability may correspond to a probability of use; e.g., a likelihood that a data attribute will be shared with the online service. In another example, the measure of probability may be further specified as a probability of sharing for a certain purpose, such as data use purpose 168b, for a certain data use timeframe, such as data use timeframe 168c, and/or for a certain data storage timeframe, such as data storage timeframe 168d.

The module may be further configured to communicate with a data aggregation program 169, located on server 126, according to which data is collected from a subset of a user population. In one example, an online service 104 may have a need for user data, for learning purposes for example, that may be satisfied by sampling data related to user activity from a subset of a larger user population, as opposed to recording all data from all users in the user population. By collecting only the data needed, each user in the larger user population will have a lower probability of sharing his or her user data. In this example, a user who is a member of the subset of the larger user population may have a computed probability of being selected for data aggregation.

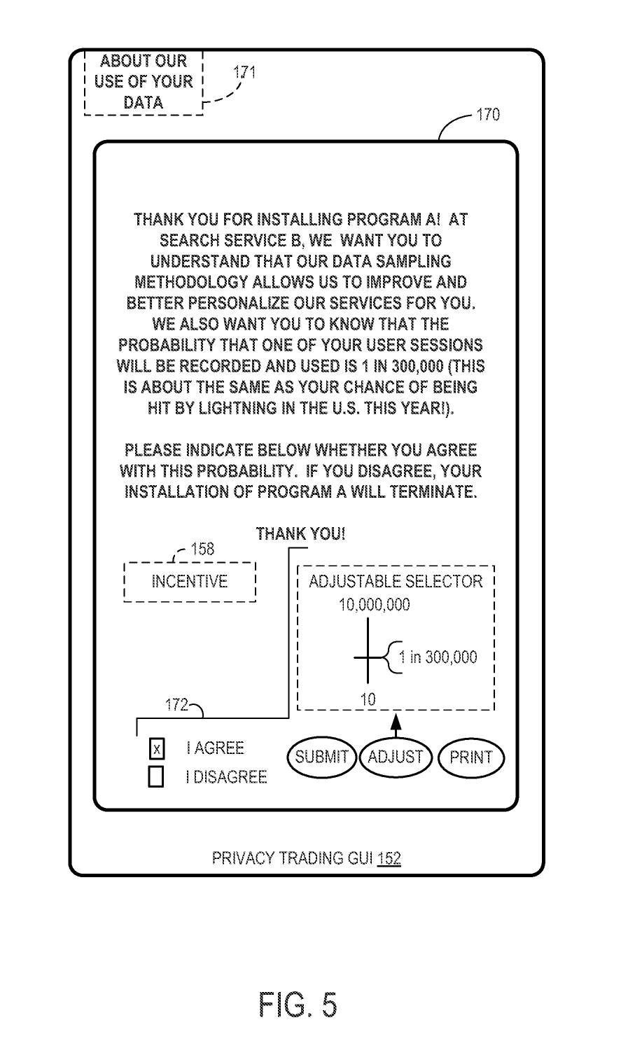

With reference now to FIG. 5, the graphical display/privacy trading GUI 152 may include a notification region 170 that provides the user with a notice and consent opportunity regarding the probability that the user's data will be shared with the online service. In one example, the computed probability may be displayed in the notification region 170 within a text block describing the probability. The notification region 170 may also include a consent selector 172 that is configured to receive user input of a consent from the user to share the user's data according to the displayed probability.

In another example, the consent selector 172 may take the form of an input mechanism that receives user input to adjust the computed probability of being selected. For example, the consent selector could alternatively or in addition take the form of a slider, similar to slider 402 shown in FIG. 4. Using the slider to adjust the computed probability of being selected, the user may thereby choose to effectively provide more or less data to the online service, and the probability figure (depicted as 1/300,000) displayed in the notice region 170 of the GUI 152 could be adjusted to a level selected by the user via the slider. In a further example, the user may be offered a benefit in exchange for selecting a higher computed probability of being selected, in a manner similar to the description above related to the probability of audit model 148, and an incentive such as incentive 158 may be displayed in the GUI 152 of FIG. 5. It will also be appreciated that, in addition to or instead of adjusting the computed probability of being selected, the slider may also be associated with the k-discriminability of the user's computed probability. In this example, the user may be informed of the k-discriminability of the computed probability in the notification region 170 of the graphical display, in addition to or instead of the probability of usage.

The measure of probability associated with sharing an associated data attribute with the online service, and/or the computed probability of being selected for data aggregation, may be presented to the user as a notice or certification of how the online service operates. In another example, the measure of probability and/or the computed probability may also be presented as a summary of how the user's data was used after a particular use session.

In another example, the notification region 170 may provide users with a description about the likelihood that their data will be used (i.e., monitored, logged and/or used in any way). The description may be presented as part of an opt-in consent agreement that may be optionally available at the outset of signing up for a service. In one example, such a description may include a range of likelihoods bounded by an upper and lower bound of the likelihood changing over time (e.g., as more people use the service, a constant data sampling rate will yield lower likelihoods per person). Such a description about the likelihood of data use may also be made available to users at any time through, for example, a tab such as tab 171 labeled “About our use of your data” that is displayed in the GUI 152 of FIG. 5.

In other examples, users may select from among one or more options on different sampling rates, such as through an input mechanism as described above in FIG. 5 that receives user input to adjust the sampling rate. The user may also be offered a more valuable benefit, such as improved service personalization or higher odds of winning a lottery, in exchange for selecting an option associated with a higher sampling rate. Such a benefit may be presented in the form of an incentive such as incentive 158 that is displayed in the GUI 152 of FIG. 5.

In a further example, aggregations, summaries or other reports of the uses of a user's data by the online service over time may be logged and/or reported to the user. The aggregations, summaries or reports may include, for example, details regarding the actual data used, statistics about the data used, parties to whom the data was disclosed, and/or other information related to data use. In other examples, the aggregations, summaries or reports may be coupled with an ability for the user to vector future data usage and/or delete data that the user desires to be removed from longer-term usage and/or collection by the online service.

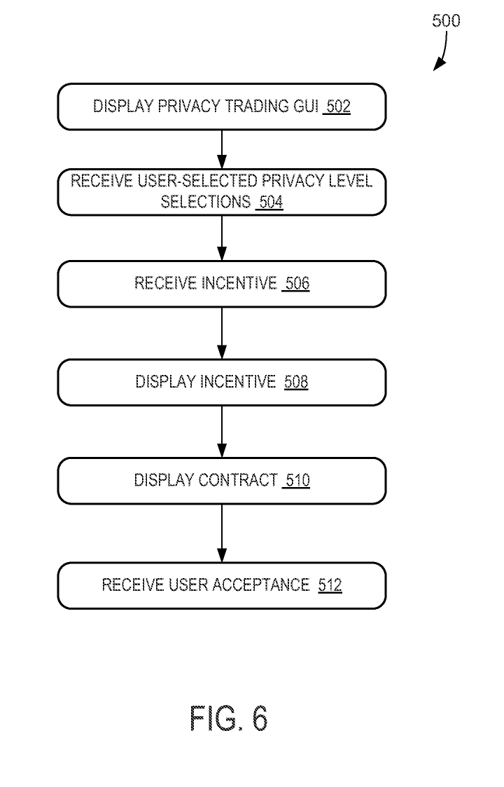

FIG. 6 is a schematic view of a flow chart for a method 500 of facilitating privacy data trading between a user of a client device and an online service according to an embodiment of the present disclosure. The following description of method 500 is provided with reference to the software and hardware components of client device 102 and online service 104 described above and shown in FIG. 1. It will be appreciated that method 500 may be also performed in other contexts using other suitable components.

At 502 the method may include displaying a privacy trading graphical user interface, such as the privacy trading GUI 152, on a display such as display 110. As described above, the privacy trading GUI 152 may include a plurality of user-adjustable privacy setting selectors 154 that are proximate to privacy data attributes 168 displayed in a privacy data attribute input interface 166. The privacy trading GUI 152 may also include an incentive display region 158 and a contract display region 162. At 504 the method may include receiving at the user-adjustable privacy setting selectors input of one or more user-selected privacy level selections 150, with each privacy level selection corresponding to a measure of identifiability for an associated privacy data attribute 168.

In one example, receiving one or more user-selected privacy level selections 150 may include receiving selections corresponding to at least one of the privacy data attributes 168 of the direct assessment model 144. As described above, in this example the data-sharing exchange engine 134 determines an incentive based on at least one of the user-selected privacy level selections 150. In another example, receiving one or more user-selected privacy level selections 150 may include receiving a plurality of selections corresponding to the data type 168a of the privacy data attributes 168 of the k-discriminability model 146. As described above, in this example the data-sharing exchange engine 134 determines an incentive based on at least aggregated privacy preference statistics. In another example, receiving one or more user-selected privacy level selections 150 may include receiving a selection corresponding to a probability that data from the user will be monitored. As described above, in this example the data-sharing exchange engine 134 determines an incentive based on at least the user-selected privacy level selection.

At 506 the method 500 proceeds by receiving the incentive from the data-sharing exchange engine 134. At 508 the method 500 displays the incentive in the incentive display region 158 as an offer in exchange for the user-selected privacy level selection(s). At 510 the method displays a contract in the contract display region 162, with the contract containing at least a text description of the user-selected privacy level selection for each of the plurality of privacy data attributes and the incentive that the user rill receive in exchange for providing the privacy data attributes to the online service 104. At 512 the method proceeds to receive the user's acceptance of the contract.

It will be appreciated that method 500 may include additional or alternative steps. As one example, the method may include storing a user profile 120 that includes pre-defined user-selected privacy level selections 150 for each of the privacy data attributes. As described above, a user profile 120 may correspond to a context in which the user may use the client device 102.

It will be appreciated that the above described systems and methods may be utilized to clearly make the user aware of user data communicated to an online service, and of a benefit received by the user in exchange for such information. Further, the systems and methods may be utilized to generate a contract providing a legal framework governing the exchange. In this manner, the service provider's use of user data is made open and overt, and control is given to the user over the type of data, the manner and length of usage of such data, and the length of storage of such data by the service provider.

The terms “module”, “engine”, “generator” and “formulator” are used herein to refer to software that performs one or more particular functions when executed by a processor of a computing device. These terms are meant to encompass individual or groups of executable files, data files, libraries, drivers, scripts, and database records, for example. The embodiments described herein show one example organization of these modules, engines, generators and formulators. However, it should be appreciated that the functions described herein may be accomplished by differently organized software components.

The term “service”, as used herein, refers to one or more server programs that are executed on one or more server devices, which collectively respond to requests from programs executed on client devices, received over a computer network to transmit information to those. The online service described herein may take the several forms described above.

It is to be understood that the example embodiments, configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

Components, process steps, and other elements that may be substantially the same in one or more embodiments are identified coordinately and are described with minimal repetition. It will be noted, however, that elements identified coordinately may also differ to sortie degree.

The subject matter of the present disclosure includes all novel and nonobvious combinations and subcombinations of the various processes, systems and configurations, and other features, functions, acts, and/or properties disclosed herein, as well as any and all equivalents thereof.

1. A system for facilitating control of data sharing between a user of a client device and an online service, the system comprising:
a module configured to display a graphical display on the client device of data sharing specifications, the graphical display including:
one or more user-adjustable privacy setting selectors configured to receive input of user-selected privacy level selections, wherein each of the privacy level selections corresponds to a measure of probability associated with sharing an associated data attribute, wherein the data attribute is selected from the group consisting of a data type, a data use purpose, a data use timeframe, and a data storage timeframe; and
a consent selector configured to receive user input of a consent from the user.

2. The system of claim 1, wherein the module is further configured to communicate with a data aggregation program according to which data is collected from a subset of a user population, the user is a member of the subset and has a computed probability of being selected for data aggregation, and the computed probability is displayed on the graphical display.

3. The system of claim 2, wherein the consent selector is configured to receive user input that adjusts the computed probability of being selected.

4. A system for facilitating privacy data trading between a user of a client device and an online service, the system comprising:
a privacy trading module configured to display a privacy trading graphical user interface on a display of the client device, the privacy trading graphical user interface including:
a plurality of user-adjustable privacy setting selectors configured to receive input of user-selected privacy level selections, wherein each of the privacy level selections corresponds to a measure of identifiability for an associated privacy data attribute, wherein the privacy data attribute is selected from the group consisting of a data type, a data use purpose, a data use timeframe, and a data storage timeframe; and
an incentive display region displaying an incentive offered in exchange for the user-selected privacy level selections.

5. The system of claim 4, wherein the privacy trading module is configured to receive the incentive from a data-sharing exchange engine of the online service via a computer network.

6. The system of claim 5, wherein the incentive corresponds to a value to the user of the user-selected privacy level selections, and the incentive is determined based on a selected payment model

7. The system of claim 6, wherein the selected payment model is a direct assessment model, and wherein the privacy trading graphical user interface receives a user-selected privacy level selection corresponding to at least one of the privacy data attributes of the direct assessment model, and wherein the incentive is determined by the data-sharing exchange engine of the online service based on at least the user-selected privacy level selection.

8. The system of claim 6, wherein the selected payment model is a k-discriminability model, and wherein the privacy trading graphical user interface receives a plurality of user-selected privacy level selections, wherein each of the selections corresponds to the data type of the privacy data attributes of the k-discriminability model, and wherein the incentive is determined by the data-sharing exchange engine of the online service based on at least aggregated privacy preference statistics.

9. The system of claim 6 wherein the selected payment model is a probability of audit model, and wherein the privacy trading graphical user interface receives a user-selected privacy level selection corresponding to a probability that data from the user will be monitored, and wherein the incentive is determined by the data-sharing exchange engine of the online service based on at least the user-selected privacy level selection.

10. The system of claim 4, wherein the privacy trading graphical user interface includes a contract display region displaying a contract that includes at least a text description of the user-selected privacy level selections for each of the plurality of privacy data attributes and the incentive that the user will receive in exchange for providing the privacy data attributes to the online service.

11. The system of claim 4, further including a user profile that includes pre-defined user-selected privacy level selections for each of the plurality of privacy data attributes, the user profile corresponding to a context in which the user may use the client device.

12. The system of claim 4, wherein the data type of the privacy data attributes is selected from the group consisting of demographic information, behavior information and geographic information, and is displayed to the user proximate to a user-adjustable privacy setting selector.

13. A method of facilitating privacy data trading between a user of a client device and an online service, the method comprising:
displaying a privacy trading graphical user interface on a display of the client device, the privacy trading graphical user interface including:
a plurality of user-adjustable privacy setting selectors, wherein each of the selectors is proximate to a privacy data attribute, wherein the privacy data attribute is selected from the group consisting of a data type, a data use purpose, a data use timeframe, and a data storage timeframe; and
an incentive display region;
receiving at the user-adjustable privacy setting selectors input of a user-selected privacy level selection, the privacy level selection corresponding to a measure of identifiability for an associated privacy data attribute; and
displaying an incentive in the incentive display region, wherein the incentive is offered in exchange for the user-selected privacy level selection.

14. The method of claim 13, further comprising receiving the incentive from a data-sharing exchange engine of the online service.

15. The method of claim 14, wherein the incentive corresponds to a value to the user of the user-selected privacy level selection, and the incentive is determined based on a selected payment model.

16. The method of claim 15, wherein the selected payment model is a direct assessment model, and further comprising receiving a user-selected privacy level selection corresponding to at least one of the privacy data attributes of the direct assessment model, and wherein the incentive is determined by the data-sharing exchange engine of the online service based on at least the user-selected privacy level selection.

17. The method of claim 15, wherein the selected payment model is a k-discriminability model, and further comprising:
receiving a plurality of user-selected privacy level selections, wherein each of the selections corresponds to the data type of the privacy data attributes of the k-discriminability model, and wherein the incentive is determined by the data-sharing exchange engine of the online service based on at least aggregated privacy preference statistics.

18. The method of claim 15, wherein the selected payment model is a probability of audit model, and further comprising receiving a user-selected privacy level selection corresponding to a probability that data from the user will be monitored, and wherein the incentive is determined by the data-sharing exchange engine of the online service based on at least the user-selected privacy level selection.

19. The method of claim 13, further including:
displaying a contract in a contract display region of the privacy trading graphical user interface, the contract containing at least a text description of the user-selected privacy level selection for each of the plurality of privacy data attributes and the incentive that the user will receive in exchange for providing the privacy data attributes to the online service.

20. The method of claim 13, further comprising storing a user profile that includes pre-defined user-selected privacy level selections for each of the plurality of privacy data attributes, the user profile corresponding to a context in which the user may use the client device.
